(19) United States
(12) Patent Application Publication
(10) Pub. No.: US 2008/0148191 A1
(43) Pub. Date: Jun. 19, 2008

(54) Visualization of Structured Data

(76) Inventor: Markus Weinlander, Happurg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/588,705

(22) PCT Filed: Dec. 17, 2004
(86) PCT No.: PCT/EP04/53575

§ 371 Date: Aug. 8, 2006

(30) Foreign Application Priority Data
Feb. 9, 2004 (DE) 10 2004 006 285.4

(51) Int. Cl. G06F 3/048

(52) U.S. Cl. 715/854

(57) ABSTRACT

In one aspect, a device to facilitate the selection of an application provided for the processing of folder properties is provided. A first application is selected via a first link that is associated with the folder properties. A second application is selected via a second application link that is associated with an object property.

### CROSS REFERENCE TO RELATED APPLICATIONS

This application is the US National Stage of International Application No. PCT/EP2004/053575, filed Dec. 17, 2004 and claims the benefit thereof. The International Application claims the benefits of German application No. 102004006285.4 DE filed Feb. 9, 2004, both of the applications are incorporated by reference herein in their entirety.

### FIELD OF INVENTION

The invention relates to a device and a method for visualizing structured data, wherein the structured data contains at least one folder containing objects and/or further folders, wherein folders can be represented in each case by means of a folder icon using display means and wherein at least one folder property can be processed by at least one first application, wherein the contents of the respective folder can be selected for representation by the display means using first selection means that are linked to the folder icon, wherein objects can be represented in each case by means of an object icon using the display means and wherein at least one object property can be processed by at least one second application, the respective second application being selectable by second selection means that are linked to the object icon for the purpose of executing the processing of the respective object property.

### BACKGROUND OF INVENTION

Such a device and such a method are known from U.S. Pat. No. 5,923,328 A.

### SUMMARY OF INVENTION

An object underlying the invention is to simplify the selection of the applications provided for processing folder properties.

This object is achieved by a device having the features recited in the independent device claim. The device serves for visualizing structured data, the structured data containing at least one folder which contains objects and/or further folders, each folder being representable by means of a folder icon using display means and at least one folder property being able to be processed by at least one first application, the contents of the respective folder being selectable for representation by the display means using first selection means that are linked to the folder icon, each object being representable by means of an object icon using the display means and at least one object property being able to be processed by at least one second application, the respective second application being selectable by second selection means for the purpose of executing the processing of the respective object property, the respective first application being selectable by third selection means displayed in addition to the folder icon using the display means for the purpose of executing the processing of the respective object property.

The object is achieved by a method having the features recited in the independent method claim. The method serves for visualizing structured data, the structured data containing at least one folder which contains objects and/or further folders, each folder being represented by means of a folder icon using display means and at least one folder property being able to be processed by at least one first application, the contents of the respective folder being selectable for representation by the display means using first selection means that are linked to the folder icon, each object being represented by means of an object icon using the display means and at least one object property being able to be processed by at least one second application, the respective second application being selectable by second selection means linked to the object icon for the purpose of executing the processing of the respective object property, the respective first application being selectable by third selection means represented in addition to the folder icon using the display means for the purpose of executing the processing of the respective object property.

In the visualization of structured data containing folders and objects, folders typically possess different folder properties. However, only the folder property indicating that the folder contains objects and/or further folders is displayed as the folder icon. The folder is opened, i.e. the contents of the folder are displayed, by selection of the folder icon, e.g. by means of a double-click on the folder icon. Further folder properties were previously not directly visible or are displayed as a separate object together with other objects in the folder contents provided the folder is open. The idea underlying the invention is to make further folder properties directly accessible to a user. This is achieved by the representation of third selection means—in addition to the folder icon—for selection of the respective first application for the purpose of executing the processing of the respective folder property. By the representation of the third selection means in direct relation to the respective folder icon it is made possible for a user to register intuitively which properties of a folder can be processed by which application and to select these as necessary.

The invention is to be applied particularly advantageously when the structured data is structured in the form of a tree structure. In such a tree structure, objects are represented as leaves and in each case are assigned to precisely one folder. A folder can likewise be assigned to precisely one further folder and contain objects as well as further folders.

In order to map the logical structure of the data in the representation of the data as realistically as possible, according to an advantageous embodiment of the invention the third selection means can be represented on the same logical level as the respective folder icon.

According to a further advantageous embodiment of the invention, a particularly flexible usability of the folder properties is achieved in that folder properties can be copied.

In order to be able to provide a user with more precise information about the respective properties or, as the case may be, applications, it is proposed that the representation of the third selection means contains textual information and/or that textual information can be represented for the represented third selection means as a function of the position of a display element which can be positioned on a display area of the display means.

### BRIEF DESCRIPTION OF THE DRAWINGS

The invention is described and explained in more detail below with reference to the exemplary embodiments depicted in the figures, in which:

FIG. 1 shows a schematic representation of structured data,

FIG. 2 shows a computer system for storing and visualizing structured data,

FIG. 3 shows an example for visualizing structured data,

FIG. 4 shows a further example for visualizing structured data,

FIG. 5 shows an example for visualizing structured data by means of a device according to the invention,

FIG. 6 shows an example for visualizing structured data by means of an advantageous embodiment of the device according to the invention, and

FIG. 7 shows a further example for visualizing structured data by means of an advantageous embodiment of the device according to the invention.

### DETAILED DESCRIPTION OF INVENTION

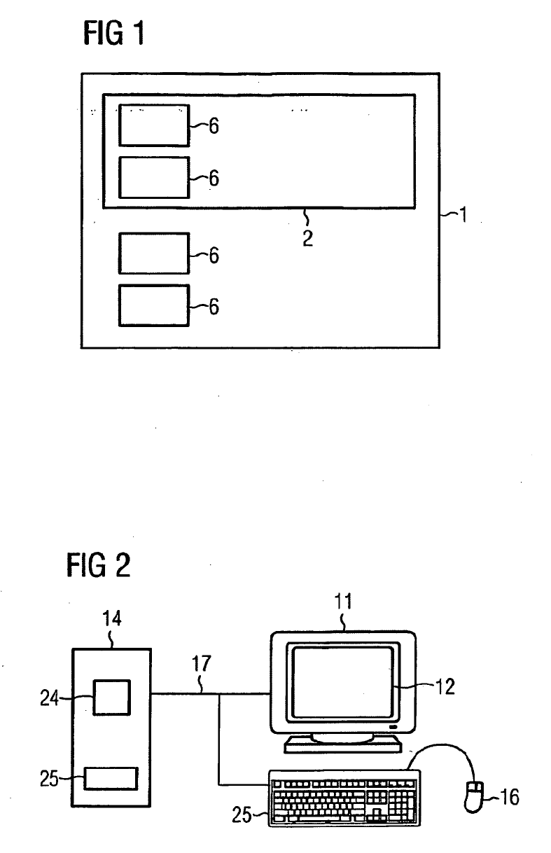

FIG. 1 shows a schematic representation of structured data. A folder 1 contains a further folder 2 as well as objects 6. The further folder 2 also contains objects 6. Both folders 1, 2 and objects 6 can have different properties. Folders 1, 2 typically are used for the structuring of data or information. Folders 1, 2 can have a name, can be renamed, can be copied, removed and/or added. However, folders 1, 2 can also have properties of an object, e.g. contain editable data. Typical objects 6 are files or documents which can be processed and/or executed by applications.

FIG. 2 shows a computer system for storing and visualizing structured data. The computer system has a computer 14 which is linked via connections 17 to display means 11 as well as to input means, in this case in the form of a keyboard 15 and a computer mouse 16. The display means 11 have a display area 12. The computer 14 has a central processing unit 25 (CPU) as well as storage means 24 for storing data. Data can be represented by means of the display area 12 of the display means 11. User inputs by a user can be made via the input means 15, 16.

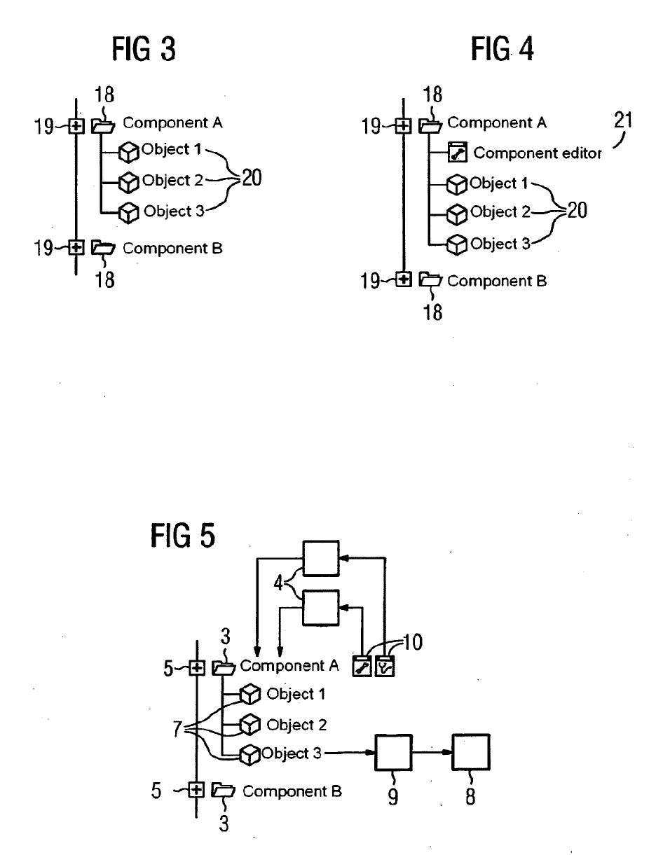

FIG. 3 shows an example depicting the visualizing of structured data. The structured data according to the exemplary embodiment shown in FIG. 3 consists of data records generated during the configuration of an industrial automation system. Components for which individual configuration files exist as objects 20 are represented by means of folder icons 18. Possibly present contents of the folders 18 can be selected for representation using selection means 19. Double-clicking the object icons 20 causes an application linked with these object icons to be launched, by means of which application the object represented by the object icons 20 or, as the case may be, the corresponding file can be processed. Such a representation of all the objects of an automation project is often required, particularly during the design of user interfaces in the industrial automation engineering environment. In such a context use is frequently made of what is referred to as a “tree control” according to FIG. 3. A representation of this kind essentially serves for navigating in the project, i.e. the aim is to enable the user to recognize the assignment of objects and hierarchically superior elements (e.g. components) as well as to select objects for processing. In a tree there are, for this purpose, folders 18 (in FIG. 3 e.g. “Component A”, “Component B”) and leaves 20 (“Object 1”, “Object 2”, “Object 3”). The tree representation becomes problematic in the case of objects that have both folder and leaf character. In FIG. 3, “Component A”, for example, could consist of the (subordinate) objects “Object 1” etc. At the same time, however, “Component A” has a wiring diagram that links the three subordinate objects with one another. Usability tests have shown that in the case of folders 18 (such as “Component A”) users generally do not suspect the presence any further objects such as a wiring diagram. Users would therefore scarcely hit on the idea of double-clicking on the folder icon designated by “Component A” or open the context menu in order to open a wiring diagram therewith. In the case shown in FIG. 3 a user is not shown directly that “Component A” is both folder and object. The folder 18 itself also carries the object, but without representing the latter, i.e. the tree presents itself as in FIG. 3, without revealing the additional properties and functions of the folder 18.

FIG. 4 shows a further example for the visualization of structured data. In contrast to the example according to FIG. 3, the first folder 18 shown, which is intended to represent a component A, contains not only the objects or, as the case may be, object icons 20 but also a further element 21 which symbolizes a link to a component editor. By selecting said element 21, e.g. once again by double-clicking the element 21, the user therefore starts a component editor, for the purpose of editing the component A in the example illustrated. In contrast to the object icons 20, which represent objects that are part of the component A, the element 21 does not refer to a part of the component A, but to the component A itself. The representation of the element 21 together with the object icons 20 on one logical level therefore does not correspond to the logical structure that is actually present. The object attached to the folder is represented in the folder contents, which does not, however, have to correspond to the semantics of the object. In the example shown it is rather the wiring diagram—designated as “Component editor” in FIG. 4—that also contains the hierarchically inferior objects. In the tree, however, “Component editor” and actually subordinate objects are represented as equal in rank and unrelated.

FIG. 5 shows an example for the visualization of structured data by means of a device according to the invention. In this case the visualization of the structured data, e.g. using display means 11 according to FIG. 2, includes folder icons 3, first selection means 5, object icons 7, and third selection means 10. The applications 4 shown in addition in FIG. 5 together with second selection means 9 and the second application 8 serve for illustration purposes, but are not displayed using the display means. In addition to the property of a structuring folder, the first folder icon 3, which represents a component A, is assigned further properties which are represented symbolically by the third selection means 10. In this case the third selection means 10 are represented directly alongside the folder icon 3 or, as the case may be, the name of the folder shown. By selecting the third selection means 10 shown, e.g. by double-clicking with the aid of a computer mouse 16 according to FIG. 2, the user in each case launches a first application 4 which is provided for processing the respective property of the component A or, as the case may be, the folder. Using second selection means 9 linked to the respective object icon 7, a second application 8 can be selected for executing the processing of an object property. The solution proposed here therefore provides what is more or less an additional dimension for the tree control. In addition to the tree-like representation it is possible that a row may contain additional objects. This means that a row presents not only a folder but also the associated object. FIG. 5 shows a possible instance: In this case an additional pictogram has been inserted in the row “Component A” as third selection means 10. Clicking the folder icon 3 causes the folder to be selected, while clicking the editor icon causes the editor to be selected or, as the case may be, opened. It is also conceivable to tie a plurality of objects to a folder. In the example according to FIG. 5, a wiring diagram (identified by the editor icon) and also a diagnostic object (identified by the stethoscope) are available in the case of the “Component A”.

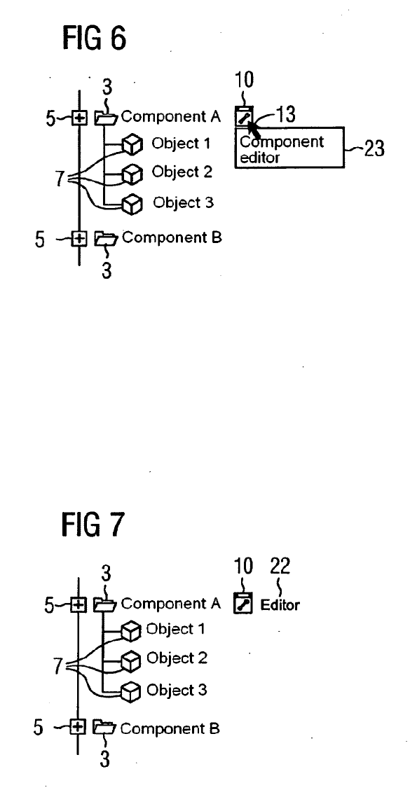

FIG. 6 shows an example for the visualization of structured data with an advantageous embodiment of the device according to the invention. In FIG. 6 and FIG. 7, elements with the same function are designated by the same reference numerals as in FIG. 5. In the exemplary embodiment according to FIG. 6, a user can initiate the representation of textual information 23 by positioning a positionable display element 13, e.g. what is known as a cursor. As soon as the display element 13 positionable by the user is situated within specifiable proximity to the third selection means 10 shown, the textual information 23, which serves to describe the third selection means 10 shown, is automatically popped up in this case. The user is thus given the information concerning which application can be activated by selecting the selection means 10. A help window of this kind, which appears when hovering over an icon with the mouse and by means of which a user can learn the meaning of the icon, is also referred to as a tool tip.

FIG. 7 shows a further example for the visualization of structured data with an advantageous embodiment of the device according to the invention. In the exemplary embodiment according to FIG. 7, textual information 22 is continuously displayed directly next to the representation of the third selection means 10, said textual information 22 naming or describing the third selection means 10. In this case the user can also open e.g. the editor by double-clicking on the text field “Editor”.

The essential advantage of the invention is that folder object constructs can be represented in the same way as they also actually behave, i.e. the object portion of a folder does not lie underneath the folder, but is situated directly next to the folder. The representation therefore corresponds to the logical relationship. At the same time the folder portion is not hidden, but can be seen directly in the user interface. Users who are not familiar with the system behavior see, as a result of the icon or text, that further objects are present here. Finally, the object portion can be selected individually and e.g. copied. Thus, for example, the interconnection (wiring) logic could be copied and transferred to other components, yet without copying the complete folder (including the hierarchically inferior objects). This makes project navigation easier and quick to learn and possibly also more efficient to use.

Summing up, the invention therefore relates to a device and a method for visualizing structured data. In order to simplify the selection of the applications provided for processing folder properties, a device for visualizing structured data is proposed wherein the structured data contains at least one folder containing objects and/or further folders, folders 1, 2 in each case being representable by means of a folder icon using display means and at least one folder property being able to be processed by at least one first application, the contents of the respective folder 1, 2 being selectable by first selection means linked to the folder icon for representation using the display means, objects in each case being representable by means of an object icon using the display means, and at least one object property being able to be processed by at least one second application, the respective second application being selectable by second selection means linked to the object icon for the purpose of executing the processing of the respective object property, characterized in that the respective first application can be selected by third selection means, represented in addition to the folder icon using the display means, for the purpose of executing the processing of the respective folder property.

1.-12. (canceled)

13. A device for visualizing structured data via a display mechanism associated with a computing device, the device comprising:
a first and a second application;
a folder having a folder property processed by the first application;
a folder icon representing the folder and displayed via the display mechanism;
a first application link linked to the first application, the link displayed via the display mechanism;
an object having an object property processed by the second application;
an object icon representing the object and displayed via the display mechanism;
a second application link linked to the second application, the link displayed via the display mechanism; and
a folder selection mechanism for displaying a content of the folder;
wherein the first application is selected via the first application link,
wherein the second application is selected via the second application link, and
wherein the folder includes an element selected from the group consisting of a further folder, the object, and combinations thereof.

14. The device as claimed in claim 13, wherein the folder properties are copyable.

15. The device as claimed in claim 13, wherein the element is generated during the configuration of an industrial automation system.

16. The device as claimed in claim 13, wherein the structured data is structured in the form of a tree structure.

17. The device as claimed in claim 16, wherein a display of the first application link is displayed on a same logical level as the folder icon.

18. The device as claimed in claim 17, wherein the display of first application link includes an icon.

19. The device as claimed in claim 16, wherein a display of the first application link is included in the display of the folder content.

20. The device as claimed in claim 16, wherein the computing device is part of an industrial automation system.

21. The device as claimed in claim 16, further comprising:
a selection mechanism; and
a textual information for the first application,
wherein the textual information is displayed when the selection mechanism is in a proximity of the first link.

22. The device as claimed in claim 21, wherein the textual information is dependent on the position of a display element positioned on a display area of the display mechanism.

23. A method for visualizing structured data via a display mechanism associated with a computing device, comprising:
providing the structured data having a folder with a folder property, the folder including an element selected from the group consisting of a second folder, an object with an object property, and combinations thereof;
providing a first application for processing the folder property;
providing a second application for processing the object property;
providing a folder icon representing the folder, an object icon representing the object, and a component icon representing a first application, the icons displayable by the display mechanism;
displaying the structured data via the display mechanism;
displaying a content of the folder via the folder icon;
launching the second application via the object icon; and
launching the first application via the component icon.

24. The method as claimed in claim 23, wherein the structured data is displayed in the form of a tree structure.

25. The method as claimed in claim 24, wherein the component icon is displayed at a same hierarchically level as the folder icon.

26. The method as claimed in claim 25, further comprises copying the folder properties.

27. The method as claimed in claim 25, further comprises displaying a textual information regarding the component icon.

28. The method as claimed in claim 28, wherein a display of the textual information is based the position of the component icon.

29. The method as claimed in claim 28, wherein the textual information is displayed when cursor is placed within proximity of the component icon.

30. The method as claimed in claim 24, wherein the computing device is part of an industrial automation system.
